(19) United States
(12) Patent Application Publication
(10) Pub. No.: US 2025/0391897 A1
(43) Pub. Date: Dec. 25, 2025

(54) CONNECTION UNIT FOR A CELL STACK

(71) Applicant: H2I GREENHYDROGEN GMBH, Wallern an der Trattnach (AT)

(72) Inventors: Dietmar Neubacher Neubacher, Graz (AT); Philipp Schneider, Graz (AT)

(21) Appl. No.: 18/879,247

(22) PCT Filed: Jun. 26, 2023
(86) PCT No.: PCT/AT2023/060202

§ 371 Date: Dec. 26, 2024

(30) Foreign Application Priority Data
Jun. 27, 2022 (AT) A 50462/2022

(51) Int. Cl. H01M 8/247; H01M 8/1004; H01M 8/2418; H01M 8/249

(52) U.S. Cl. CPC H01M 8/247; H01M 8/1004; H01M 8/2418; H01M 8/249

(57) ABSTRACT

An electrochemical device may include an attachment device, a plurality of stackable electrochemical cells, and an operating device. The plurality of electrochemical cells may be arranged in a stack starting from a first attachment zone of the attachment device along a first normal axis and form a first cell stack. The plurality of electrochemical cells may be arranged in a stack starting from a second attachment zone of the attachment device along a second normal axis and form a second cell stack. The attachment device may include a common support element. The first attachment zone and the second attachment zone may be jointly arranged on the common support element.

### CROSS-REFERENCE TO RELATED APPLICATIONS

This application claims priority to International Patent Application No. PCT/AT2023/060202, filed on Jun. 26, 2023, and Austrian Patent Application No. A 50462/2022, filed on Jun. 27, 2022, the contents of both of which are hereby incorporated by reference in their entirety.

### TECHNICAL FIELD

The invention relates to an electrochemical device comprising an attachment device, stackable electrochemical cells and an operating means device. The electrochemical device according to the invention can in particular be used for the electrolytic generation of hydrogen in conjunction with anion-exchange membranes in the electrochemical cells. In the present electrochemical device according to the invention, electrochemical cells are arranged in a stack starting from an attachment zone of the attachment device along a first normal axis to a first attachment zone so as to form a first cell stack. The attachment device comprises an attachment group with a first and a second attachment member. The cell stack can be coupled to the operating means device in a fluid manner by means of the attachment members or by means of at least one attachment member and thus be supplied with electrolyte on the one hand and/or product gas can be discharged from the cell stack on the other hand.

### BACKGROUND

Various embodiments of electrochemical device structures are known from the prior art. The specification DE 10259386 A1, for example, shows a pressure electrolyzer with a pressure vessel and an electrolytic cell block made up of stacked electrolytic cells, as well as two end plates between which the electrolytic cell block is clamped. Furthermore, the specification WO 2015102479 A1 shows a fundamentally similar structure with a cell stack between two end plates.

In large-scale systems for electrolytic hydrogen generation or for conversion of hydrogen to electricity, a plethora of such electrolysis or fuel cell devices with the structure described above known from the prior art are used. However, this described basic structure of an electrolysis or fuel cell device is disadvantageous with regard to operational safety as well as economical production, maintenance and operation when used in a large-scale system.

### SUMMARY

The problem to be solved of the present invention was to overcome the disadvantages of the prior art and to provide a device to overcome the disadvantages of the prior art.

This object is solved by a device and a method according to the claim(s).

The electrochemical device according to the invention comprises an attachment device, stackable electrochemical cells, in particular electrolysis or fuel cells, and an operating means device. The electrochemical cells are arranged in a stack starting from an attachment zone of the attachment device along a first normal axis to the first attachment zone and form a first cell stack. The attachment device comprises a first attachment group in the region of the first attachment zone, wherein the first cell stack can be coupled to the operating means device in a fluid manner by means of the first attachment group. The first attachment group comprises a first attachment member and a second attachment member such that the first cell stack can be supplied with electrolyte via the first attachment group and/or product gas can be discharged from the first cell stack via the first attachment group. Furthermore, the attachment device has a common support element, on which the first attachment zone and at least one second attachment zone are jointly arranged. The electrochemical cells are arranged in a stack starting from the second attachment zone of the attachment device along a second normal axis to the second attachment zone and form a second cell stack. The attachment device comprises a second attachment group in the region of the second attachment zone, wherein the second cell stack can be coupled to the operating means device in a fluid manner by means of the second attachment group. The second attachment group comprises a third attachment member and a fourth attachment member such that the second cell stack can be supplied with electrolyte via the second attachment group, and/or product gas can be discharged from the second cell stack via the second attachment group.

In the electrochemical device according to the invention, an attachment device for at least two cell stacks is used jointly, wherein the first and the second cell stack are each coupled to the operating material device in a fluid manner via the attachment members of their respective attachment group. The attachment device can receive the first cell stack in conjunction with a first end plate and receive the second cell stack in conjunction with a second end plate. Both cell stacks are thus simultaneously held on the attachment device. The attachment device can therefore function as a stable support platform for the at least two cell stacks.

Furthermore, the electrochemical device according to the invention facilitates miniaturization or modularization of the electrochemical cells or of the single plate-shaped individual components of the cell stacks. The number of individual components can be increased compared to conventional designs as a result, which improves cost-effectiveness in the production of the electrochemical device. A synergistic secondary effect of the electrochemical device according to the invention is that lower cell voltages can be achieved with a total of more and therefore structurally smaller stacks during operation of the electrochemical device in the electrolytic generation of hydrogen, for example.

It can further be expedient for the attachment device to be configured with an integral connection. This leads to particular stability of the attachment device, which can absorb the torsion caused by receiving the cell stacks and provide the electrochemical device with the necessary stability. This also consequently ensures that the respective attachment group is located in an attachment zone and that no twisting of the attachment zones occurs.

It can further be provided that the attachment device is formed as one piece. This in turn can increase the stability of the attachment device and thus, subsequently, the stability of the entire electrochemical device.

In addition, it can be provided that the first attachment zone is formed in a first attachment plane of the attachment device and the second attachment zone is formed in a second attachment plane of the attachment device, the first attachment plane being arranged parallel to and spaced apart from the second attachment plane. The first attachment zone can thus be arranged opposite the second attachment zone. It is possible to further reduce the number of individual components of the electrochemical device in this way, since a region of the attachment element, in which the first and second attachment planes are arranged opposite one another, can be used for two cell stacks.

It can also be expedient for the attachment planes to be oriented at an angle to one another. For example, an embodiment at an angle of 90° is conceivable, the attachment device also having a common support element, on which the two attachment zones are formed.

Another embodiment is advantageous, according to which it can be provided that the first normal axis and the second normal axis are aligned congruently to one another. Thus, in the case of attachment zones arranged opposite one another, the cell stacks are arranged linearly along their axes, meaning that common connection elements of the cell stacks can be used for connection to their end plates and the attachment device. This in turn leads to a reduction in the individual components of the electrochemical device and thus to financial benefits, but also to reduced complexity in the assembly of the electrochemical device.

According to an advancement, it is possible for the first normal axis and the second normal axis to be aligned parallel to and offset from one another. In this way, in the case of opposite attachment planes of the attachment device, a respective independent mounting of the cell stacks on the attachment element can be provided, wherein the attachment device continues to function as a common support element for the two cell stacks at the same time.

Furthermore, it can be expedient for the first attachment zone and the second attachment zone to be arranged in a common attachment plane of the attachment device such that the first normal axis and the second normal axis are arranged parallel to one another and spaced apart from one another. The cell stacks can thus be arranged next to one another, which results in a reduced degree of complexity, in particular for assembly and maintenance of the electrochemical device, since a central support element for the cell stacks is used with the attachment device.

In addition, it can be provided that the first attachment member of the first attachment group can be coupled to the third attachment member of the second attachment group in a fluid manner by means of a first fluid channel to the operating means device, and the second attachment member of the first attachment group can be coupled to the fourth attachment member of the second attachment group in a fluid manner by means of a second fluid channel to the operating means device, wherein the first fluid channel and the second fluid channel are formed internally or integrated in the attachment device. In this way, a further component reduction of the electrochemical device can be achieved, since individual lines as well as line connection elements and line monitoring elements are replaced by the internal fluid channels. This significantly lowers the assembly time of the electrochemical device and lowers the proneness to faults during assembly. Furthermore, the safety of the electrochemical device can be increased in this way, since fewer pipe connections have to be checked for tightness, which is particularly advantageous in the electrochemical device according to the invention, since the media comprise electrolyte and gas.

As a result of the overall reduction in components, there is a reduction in components in contact with alkaline liquids, which subsequently also results in a lesser risk of liquid contact during maintenance or dismantling work. Furthermore, the component reduction results in a reduction in weight compared to conventional arrangements with individual end plates and cell stacks individually coupled in a fluid manner, since the attachment device is also configured to be hollow or lighter with internal fluid channels.

Furthermore, it can be provided that the first fluid channel and the second fluid channel are each configured as a bore, wherein the first fluid channel and the second fluid channel each extend from a lateral surface of the attachment device and are guided past the first attachment zone and the at least one second attachment zone. This facilitates precise production of the fluid channels, for example compared to the casting production method. Furthermore, processing the bore surfaces is enabled with a corresponding choice of tools, so that in particular the desired surface properties of the bores can be set with regard to optimum flow control of the fluids in the fluid channels. Provision can be made for the bores extending from the lateral surface to be used exclusively for connecting the attachment members in the interior of the attachment device, and thus for the bore inlet on the lateral surface of the attachment device to be closed. As a further consequence, access to the respective fluid channel can be created from any other surface of the attachment device, by which the respective fluid channel can be coupled to the operating means device in a fluid manner. The position of the coupling of the respective fluid channel to the equipment device on the attachment device can thus be variably selected and the installation situation of the attachment device and the cell stacks within the electrochemical device can thus be optimally considered.

According to a particular embodiment, it is possible for the attachment device to be formed in two parts from a first partial element and a second partial element, wherein the first partial element comprises the first attachment zone, and wherein a first cross-sectional half of the first fluid channel is formed predominantly in the first partial element and a second cross-sectional half of the first fluid channel is formed predominantly in the second partial element. Doing so makes possible in a simple manner that the fluid channels can be produced by processing the respective partial elements. A CNC milling method is conceivable, for example, in which, after appropriate processing of the fluid channels, the attachment device composed of the partial elements is joined together into one piece. In addition, dividing the attachment device into two partial elements offers the advantage that the fluid channels, after these have been formed, can be treated in a simple manner by means of a further method, such as a surface coating. This offers the further advantage that the attachment device, in line with the requirements thereof for the stability of the entire electrochemical device, can be provided with recesses due to the division into two partial elements in order to bring about a reduction in weight. Among other things, this is advantageous as it simplifies handling the attachment device, for example during assembly, disassembly or maintenance.

Furthermore, the two-part structure of the attachment device makes it possible to guide the fluid channels or configure the fluid channels specifically and corresponding to the requirements of the individual cell stacks. It is conceivable, for example, for the first fluid channel to have a cross-sectional profile that tapers conically in the flow direction over its longitudinal profile. As a result, specific sections that change the flow pattern over the flow path, such as a throttle element, can also be integrated directly into a flow channel. This in turn reduces the number of necessary individual components of the electrochemical device if, as mentioned in the example, a throttle element is already integrated in the attachment device, for example, and need not be integrated in a further pipeline.

According to an advantageous advancement, it can be provided that the second partial element comprises the second attachment zone. In this way, it is possible to reduce weight and save on materials. The attachment device can thus also be fully utilized on both sides, resulting in a reduction of components when several electrochemical devices are used in a large-scale system.

It can be particularly advantageous for the attachment device to be formed in three parts from a first partial element, a second partial element and a third partial element wherein the first partial element comprises the first attachment zone and the second partial element comprises the second attachment zone, wherein the third partial element is arranged between the first partial element and the second partial element, and wherein the first fluid channel is formed predominantly in the third partial element. This especially enables simplification of production of the fluid channels. It is conceivable for the first partial element and the second partial element to be made of a metallic material with a high load capacity, whereas the third partial element is made of a material that is easier to process and is causes less tool wear during processing. A conceivable advantage would be to produce the third partial element from an injection-molded part, whereby the fluid channels can also be produced in a simple, precise and cost-effective manner. In any case, it can be advantageous for the fluid channels and, if appropriate, for further elements influencing the flow guidance to be formed at least predominantly in the third partial element.

It can further be provided that the first fluid channel comprises a throttle element, wherein the throttle element is integrated, formed or arranged inside of the attachment device. By integrating the throttle element, this component can be omitted as a further add-on part to the attachment device, this achieving a reduction in components of the electrochemical device.

It can further be provided that the attachment members are configured as elongate boreholes, wherein the elongate boreholes are each configured as a circular segment-shaped elongate hole along a circular diameter about the normal axis associated with the respective attachment zone. Use of the attachment device can thus be multifaceted. In particular, it is a conceivable advantage that the attachment device can thus be used for different electrochemical cells arranged adjacent thereto, which is also advantageous with regard to further use of the attachment device for various cell developments.

An embodiment is also advantageous, according to which it can be provided that the first cell stack is mounted between a first end plate and the attachment device and that the second cell stack is mounted between a second end plate and the attachment device, wherein the first end plate is coupled to the attachment device by means of a first connection element and the second end plate is coupled to the attachment device by means of a second connection element respectively. In this way, a single cell stack can be replaced without having to disassemble the entire electrochemical device. This also simplifies the pre-assembly of the individual components of the electrochemical device. It is also advantageous for cell stacks with different numbers of cells to thus be used on the same attachment device, wherein each cell stack can adapt to corresponding thermal expansions during operation. It is also a conceivable advantage for the respective end plates to be mounted loosely on a frame element of the electrochemical device, so that the respective cell stacks can individually adapt to the corresponding thermal expansions.

According to a further advancement, it is possible for the attachment device to comprise a fastening element on a mounting surface, wherein the attachment device can be received or held on a housing or in a frame by means of the fastening element. In this way, the attachment device, in conjunction with the frame, assumes the support function for the entire electrochemical device, and the electrochemical device can be integrated as an entire unit into an overall system. For example, it can be advantageous for the frame, and thus the entire electrochemical device, to be integrated into a cabinet or shelf provided for this purpose. The electrochemical device can thus be integrated into a large-scale system as a modularized unit.

It can further be expedient for the stackable electrochemical cells to comprise an anion-exchange membrane. When AEM technology is used in the electrochemical device according to the invention, it is particularly advantageous for the cell stacks of electrochemical cells to be particularly easy to replace, since this technology is currently undergoing repeated development steps and, accordingly, different development generations can also be used as a central platform on the existing attachment device. Due to the constant further development of AEM technology, the dimensions of the electrochemical cells, for example, can also change, whereby the same attachment device can still be used.

An advantageous advancement can also be provided, wherein the first cell stack comprises a first connection member and the second cell stack comprises a second connection member, wherein the respective connection member can be used to position the stacked electrochemical cells in a fixed position relative to one another. The respective connection member can be formed, for example, by a tube, shrinkable tube, or by another enveloping or encasing connection member, which encloses the stacked electrochemical cells in the circumferential direction. It is also conceivable for the respective cell stack to be wrapped, for example, with a fabric tape or the like, and for the respective connection member to be formed thus. Furthermore, a conceivably advantageous embodiment can be configured such that the individual stacked electrochemical cells are glued to one another. Furthermore, it is conceivable for the stacked individual electrochemical cells to be clamped or fixed to one another by means of a corresponding clamping device of the respective connection member such that the stacked individual electrochemical cells can be held in a frictionally engaged manner with respect to one another.

It can further be expedient for the respective connection member to be formed from mutually complementary grooves and tongues in the stackable individual electrochemical cells. As a result, the electrochemical cells can form a cell stack as an assembly, wherein the individual electrochemical cells can be positively positioned with respect to one another at least partially or in sections. In all of these possible embodiments, it is advantageous for a cell stack to be formed as a common assembly of electrochemical cells held in position with respect to one another. This facilitates replacing a cell stack as a comprehensive package of individual electrochemical cells. In terms of synergism with the advantages already mentioned, this is advantageous as it significantly facilitates the assembly and maintenance of the electrochemical device for an operator and thus minimizes points of failure. It is further conceivable for a cell stack to be formed from a plurality of contiguous groups of individual electrochemical cells. This thus enables further modularization. A further synergistic secondary effect of the electrochemical device according to the invention in conjunction with contiguous groups of individual is thus that electrochemical cells is that lower cell voltages can be achieved with a total of more and therefore structurally smaller stacks or groups of cells during operation of the electrochemical device in the electrolytic generation of hydrogen, for example.

### BRIEF DESCRIPTION OF THE DRAWINGS

The figures below elaborate on the invention to offer better understanding thereof.

The figures show in greatly simplified, schematic depiction:

FIG. 1 shows a possible embodiment of the electrochemical device,

FIG. 2 shows a first possible embodiment of the attachment device,

FIG. 3 shows a further view of the attachment device,

FIG. 4 shows a second possible embodiment of the attachment device, and

FIG. 5 shows a third possible embodiment of the attachment device.

### DETAILED DESCRIPTION

It is worth noting here that the same parts have been given the same reference numerals or same component designations in the embodiments described differently, yet the disclosures contained throughout the entire description can be applied analogously to the same parts with the same reference numerals or the same component designations. The indications of position selected in the description, such as above, below, on the side etc. also refer to the figure directly described and shown, and these indications of position can be applied in the same way to the new position should the position change.

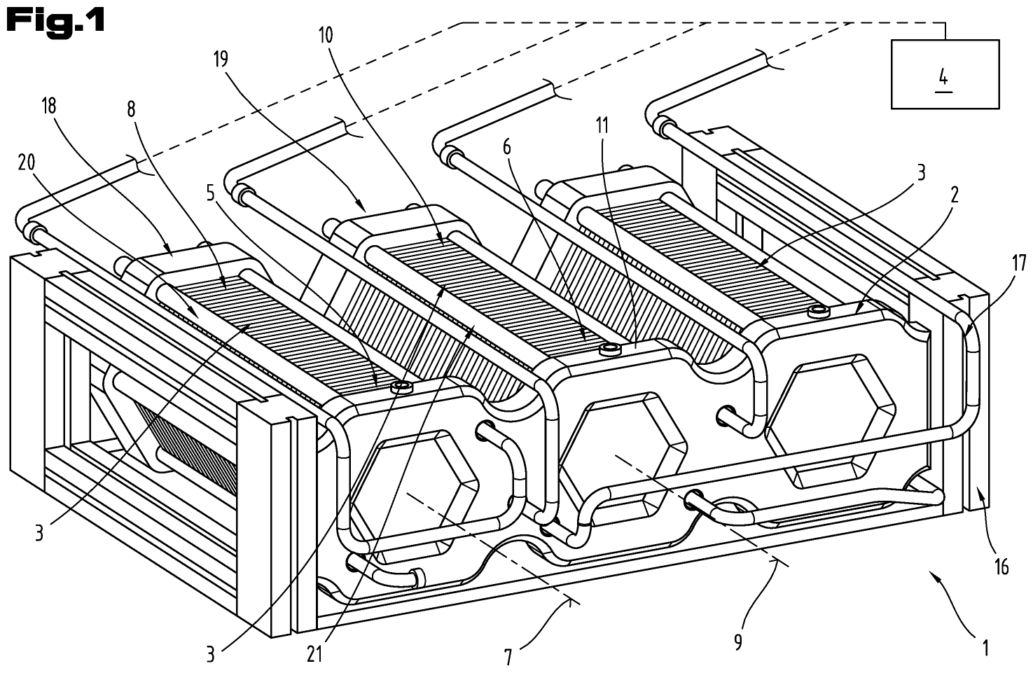

FIG. 1 shows a schematic depiction of a possible embodiment of the electrochemical device 1. The electrochemical device 1 can comprise an attachment device 2, stackable electrochemical cells 3, for example electrolysis or fuel cells, in particular electrolysis cells, however, with an anion-exchange membrane and an operating means device 4. The attachment device 2 can have a first attachment zone 5 and at least one second attachment zone 6 Electrochemical cells 3 can be arranged in a stack starting from the first attachment zone 6 along a first normal axis 7 to the first attachment zone 6 and form a first cell stack 8. Furthermore, electrochemical cells 3 can be arranged in a stack starting from the second attachment zone 6 along a second normal axis 9 and form a second cell stack 10. In this case, the first attachment zone 5 and the second attachment zone 6 can be arranged or formed on a common support element 11.

Furthermore, the electrochemical device 1 can comprise a frame 16, wherein the attachment device 2 is fastened or held on a mounting surface 17 on the frame 16 by means of a fastening element 31. A threaded hole, for example, in the attachment device 2 can be formed as a fastening element 31. The electrochemical device 1 can comprise a first end plate 18, wherein the first cell stack 8 can be mounted between the first end plate 18 and the first attachment zone 5 of the attachment device 2. The first end plate 18 can be connected to the attachment device 2 by means of a first connection element 20 such that the first cell stack 8 is fixed or held in position between the first end plate 18 and the attachment device 2. The electrochemical device 1 can comprise a second end plate 19 wherein the second cell stack 10 can be mounted between the second end plate 19 and the second attachment zone 6 of the attachment device 2. The second end plate 19 can be connected to the attachment device 2 by means of a second connection element 21 such that the second cell stack 10 is fixed or held in position between the second end plate 19 and the attachment device 2. The frame 16 of the electrochemical device 1 can be configured such that the first end plate 18 and the second end plate 19 are supported on or at a frame portion.

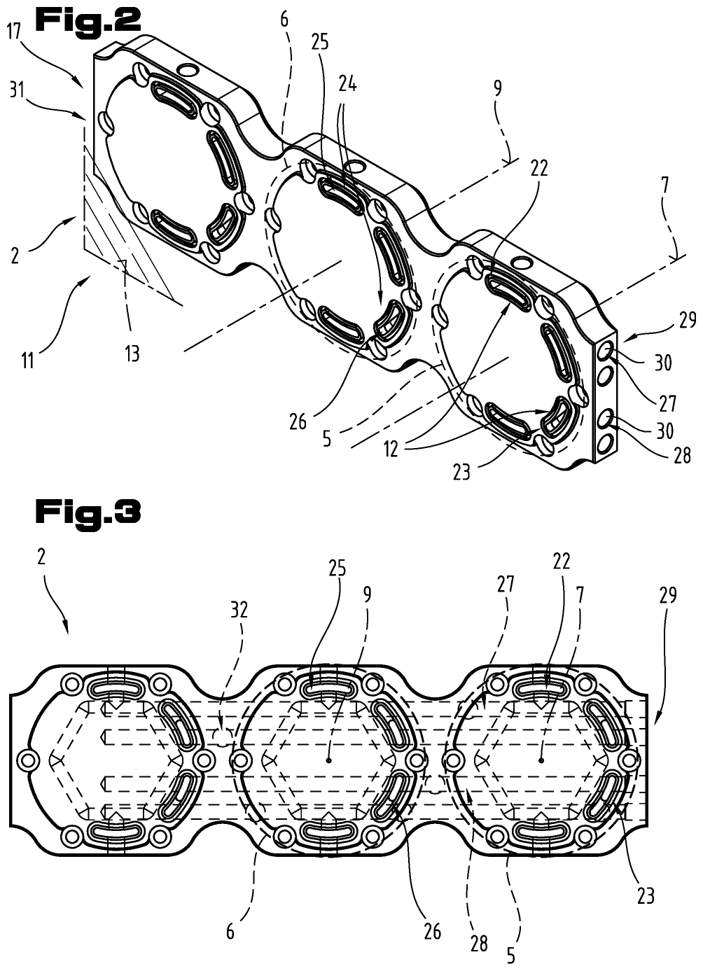

FIG. 2 shows a further, optionally independent, first possible embodiment of the attachment device 2, wherein the same reference numerals or component designations as in the preceding FIG. 1 are used again for identical parts. To avoid unnecessary repetitions, reference is made to the detailed description in preceding FIG. 1. In the possible embodiment of the attachment device 2 shown in FIG. 2, the attachment device 2 is configured as a common support element 11. In this case, the common support element 11 can be formed as one part or in one piece. As can be seen from a combination of FIG. 1 and FIG. 2, the first cell stack 8 can be formed or arranged from stacked electrochemical cells 3 starting from the first attachment zone 5 along the first normal axis 7. Furthermore, a second cell stack 10 can be formed or arranged from stacked electrochemical cells 3 starting from the second attachment zone 6 along the second normal axis 9. It can be particularly advantageous for the first attachment zone 5 and the second attachment zone 6 to be formed in a common attachment plane 13. However, embodiments of the attachment device 2 and of the electrochemical device 1 are conceivable, in which the first attachment zone 5 and the second attachment zone 6 are not located in the common attachment plane 13, but, for example, in which the first attachment zone 5 is located in a first attachment plane 14 and the second attachment zone 6 is located in a second attachment plane 15, the first attachment plane 14 being aligned congruently to the second attachment plane 15, and wherein the first attachment zone 5 and the second attachment zone 6 can still be arranged on a common support element 11.

Furthermore, the attachment device 2 can have a first attachment group 12 in the region of or within the first attachment zone 5, by means of which the first attachment group 12 of the first cell stack 8 can be coupled to the operating means device 4 in a fluid manner. In this case, the first attachment group 12 can comprise a first attachment member 22 and a second attachment member 23. The first cell stack 8 can be supplied with electrolyte via the first attachment member 22, for example, and the product gas can be discharged via the second attachment member 23 for example, when the electrochemical device 1 is used as an electrolysis device. In the same way, the attachment device 2 can have a second attachment group 24 in the region of or within the second attachment zone 6, by means of which the second attachment group 24 of the second cell stack 10 can be coupled to the operating means device 4 in a fluid manner. In this case, the second attachment group 24 can comprise a third attachment member 25 and a fourth attachment member 26. The second cell stack 10 can be supplied with electrolyte by the operating means device 4 via the third attachment member 25 for example, and the product gas can be discharged via the fourth attachment member 26 for example, when the electrochemical device 1 is used as an electrolysis device.

The attachment device 2 can have a first fluid channel 27, wherein the first attachment member 22 and the third attachment member 25 can be coupled in a fluid manner by means of the first fluid channel 27, and wherein the first attachment member 22 and the third attachment member 25 can be coupled to the operating means device 4 in a fluid manner by means of the first fluid channel 27. Furthermore, the attachment device 2 can have a second fluid channel 28, wherein the second attachment member 23 and the fourth attachment member 26 can be coupled in a fluid manner by means of the second fluid channel 28, and wherein the second attachment member 23 and the fourth attachment member 26 can be coupled to the operating means device 4 in a fluid manner. The first fluid channel 27 and the second fluid channel 28 can be formed by bores 30 in the attachment device 2. The bores 30 can be provided in a lateral surface 29 of the attachment device 2.

FIG. 3 shows a further view of the attachment device 2 of FIG. 2, however the same reference numerals or component designations as in the preceding FIGS. 1 to 2 are used again for identical parts. To avoid unnecessary repetitions, reference is made to the detailed description in preceding FIG. 1 to FIG. 2. FIG. 3 shows that the first attachment member 22 and the third attachment member 25 can be coupled in a fluid manner by means of the first fluid channel 27. It also shows that the second attachment member 23 can be coupled to the fourth attachment member 26 by means of the second fluid channel 28. The first and attachment member 22, 23 are arranged within the first attachment zone 5 and the third and fourth attachment member 25, 26 are arranged or formed within the second attachment zone 6. In the possible embodiment of the attachment device 2 shown in FIG. 3, the fluid channels 27, 28 can be configured starting from the lateral surface 29 by means of bores 30.

In order to be able to ensure an advantageous supply of electrolyte or a discharge of product gas to or from the respective cell stack 8, 10, the attachment members 22, 23, 25, 26 can be configured as banana-shaped or curved elongate holes along a circular segment about the respective normal axis 7, 9 of the respective attachment zone 5, 6.

Furthermore, the attachment device 2 can have a throttle element 32. The throttle element 32 can be coupled in a fluid manner to the first fluid channel 27 or can be configured as a partial portion of the first fluid channel 27. In any case, the throttle element 32 is integrated in the attachment device 2 or is comprised by the attachment device 2.

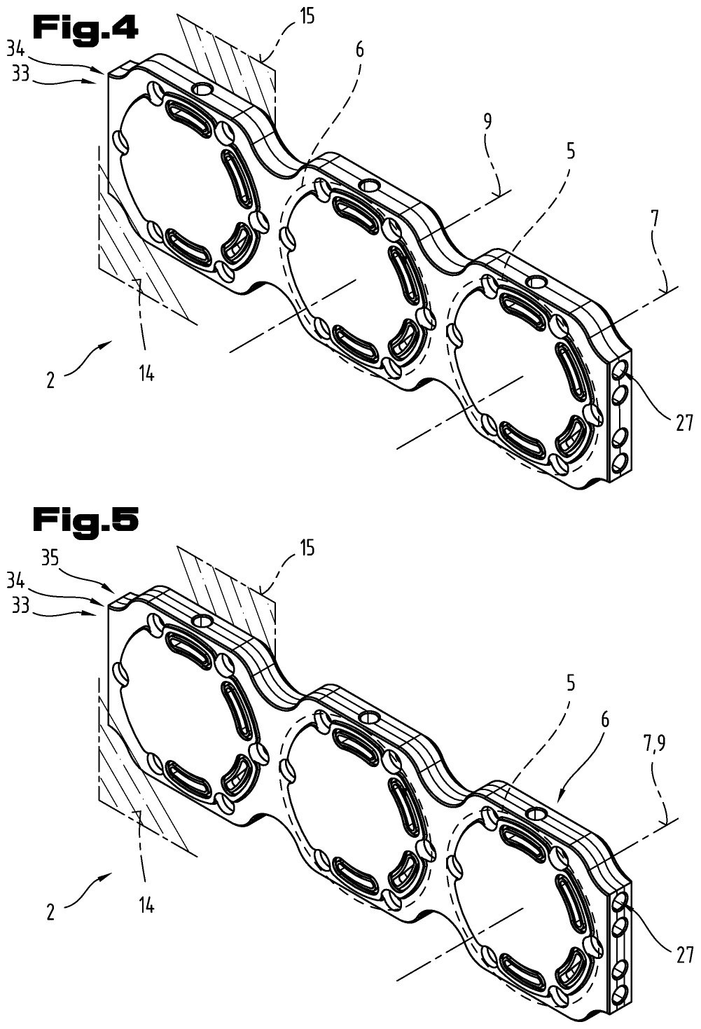

FIG. 4 shows a further, optionally independent, second possible embodiment of the attachment device 2, wherein the same reference numerals or component designations as in the preceding FIG. 1 to FIG. 3 are used again for identical parts. To avoid unnecessary repetitions, reference is made to the detailed description in preceding FIG. 1 to FIG. 3. As shown in FIG. 4, the attachment device 2 can be formed in two parts from a first partial element 33 and a second partial element 34, wherein the first attachment zone 5 is formed on the first partial element 33. It can further be provided that the second attachment zone 6 is formed on the first partial element 33. However, it is also conceivable that the first attachment zone 5 is formed on the first partial element 33 such that the first cell stack 8 is formed from stacked electrochemical cells 3 along the first normal axis 7 starting from the first attachment plane 14, and the second attachment zone 6 is formed on the second partial element 34 such that the second cell stack 10 is formed from stacked electrochemical cells 3 along the second normal axis 9 starting from the second attachment plane 15 (cf. FIG. 5). In this case, it can be provided that the normal axes 7, 9 are aligned congruently or also parallel and offset to one another. Depending on the connection element 20, 21 used, the respective cell stack 8, 10 can be held or mounted thus on the attachment device 2.

It can further be provided that a cross-sectional half of the first fluid channel 27 is formed predominantly in the first partial element 33 and a second cross-sectional half of the first fluid channel 27 is formed predominantly in the second partial element 34. As a result, the first fluid channel 27 can be produced in a simple manner, by CNC processing, for example, wherein the attachment device 2 can be configured to be integrally connected by correspondingly connecting the first partial element 33 to the second partial element 34. When the first fluid channel 27 has a corresponding cross-sectional shape, it is also conceivable for the first fluid channel 27 to be formed entirely in one of the partial elements 33, 34.

FIG. 5 shows a further, optionally independent, third possible embodiment of the attachment device 2, wherein the same reference numerals or component designations as in the preceding FIG. 1 to FIG. 4 are used again for identical parts. To avoid unnecessary repetitions, reference is made to the detailed description in preceding FIG. 1 to FIG. 4. As can be seen in FIG. 5, the attachment device 2 can be formed in three parts, comprising a first partial element 33, a second partial element 34 and a third partial element 35. However, it is also conceivable that the first attachment zone 5 is formed on the first partial element 33 such that the first cell stack 8 is formed from stacked electrochemical cells 3 along the first normal axis 7 starting from the first attachment plane 14 and the second attachment zone 6 is formed on the second partial element 34 such that the second cell stack 10 is formed from stacked electrochemical cells 3 along the second normal axis 9 starting from the second attachment plane 15. In this case, it can be provided that the normal axes 7, 9 are aligned congruently or also parallel and offset to one another. Depending on the connection element 20, 21 used, the respective cell stack 8, 10 can be held or mounted thus on the attachment device 2. In this case, the first fluid channel 27 can be completely accommodated by the third partial element 35 or integrated therein, which offers the advantage that the third partial element 35 is easily accessible for processing and the material selection of the individual partial elements 33, 34, 35 can also be adapted accordingly.

The embodiments show possible design variants, however it is noted at this point that the invention is not restricted to the design variants of the same specifically shown, rather various combinations between the individual design variants are possible and these possible variants can be developed using the knowledge of the person skilled in the art working in this field based on the teachings of technical practice offered by the current invention.

The scope of protection is determined by the claims. However, the description and the drawings are to be referenced for the interpretation of the claims. Individual features or combinations of features from the various exemplary embodiments shown and described can represent independent inventive solutions in themselves. The problem to be solved, upon which the independent, inventive solutions are based, can be derived from the description.

As a matter of form and by way of conclusion, it is noted that, to improve understanding of the structure, elements have partially not been shown to scale and/or enlarged and/or shrunk.

1. An electrochemical device, comprising an attachment device, a plurality of stackable electrochemical cells, and an operating device, wherein:
the plurality of electrochemical cells are arranged in a stack starting from a first attachment zone of the attachment device along a first normal axis to the first attachment zone and form a first cell stack;
the attachment device includes a first attachment group in a region of the first attachment zone;
the first cell stack is couplable to the operating device in a fluid manner via the first attachment group;
the first attachment group includes a first attachment member and a second attachment member such that the first cell stack is suppliable with electrolyte via the first attachment group, and/or product gas is dischargeable from the first cell stack via the first attachment group;
the attachment device further includes a common support element, the first attachment zone and at least one second attachment zone jointly arranged on the common support element;
the plurality of electrochemical cells are arranged in a stack starting from the at least one second attachment zone of the attachment device along a second normal axis to the at least one second attachment zone and form a second cell stack;
the attachment device further includes a second attachment group in a region of the at least one second attachment zone;
the second cell stack is couplable to the operating device in a fluid manner via the second attachment group;
the second attachment group includes a third attachment member and a fourth attachment member such that the second cell stack is suppliable with electrolyte via the second attachment group, and/or product gas is dischargeable from the second cell stack via the second attachment group;
the first attachment zone is formed in a first attachment plane of the attachment device and the at least one second attachment zone is formed in a second attachment plane of the attachment device;
the first attachment plane is arranged parallel to and spaced apart from the second attachment plane;
the first attachment zone is arranged opposite the at least one second attachment zone, the first attachment plane aligned congruently to the second attachment plane; and
the first attachment zone and the at least one second attachment zone are still arranged on the common support element.

2. The electrochemical device according to claim 1, wherein the attachment device is configured with an integral connection.

3. The electrochemical device according to claim 1, wherein the attachment device is formed as one piece.

4. (canceled)

5. The electrochemical device according to claim 1, wherein the first normal axis and the second normal axis are aligned congruently to one another.

6. The electrochemical device according to claim 1, wherein the first normal axis and the second normal axis are aligned parallel and offset to one another.

7. (canceled)

8. The electrochemical device according to claim 1, wherein:
the first attachment member of the first attachment group is couplable to the third attachment member of the second attachment group in a fluid manner via a first fluid channel to the operating device;
the second attachment member of the first attachment group is couplable to the fourth attachment member of the second attachment group in a fluid manner via a second fluid channel to the operating device; and
the first fluid channel and the second fluid channel are formed internally and/or integrated in the attachment device.

9. The electrochemical device according to claim 8, wherein:
the first fluid channel and the second fluid channel are each configured as a bore; and
the first fluid channel and the second fluid channel each extend from a lateral surface of the attachment device and are guided past the first attachment zone and the at least one second attachment zone.

10. The electrochemical device according to claim 8, wherein:
the attachment device is formed in two parts from a first partial element and a second partial element;
the first partial element includes the first attachment zone;
a first cross-sectional half of the first fluid channel is formed predominantly in the first partial element; and
a second cross-sectional half of the first fluid channel is formed predominantly in the second partial element.

11. The electrochemical device according to claim 10, wherein the at least one second attachment zone is arranged on the second partial element.

12. The electrochemical device according to claim 8, wherein:
the attachment device is formed in three parts from a first partial element, a second partial element, and a third partial element;
the first partial element includes the first attachment zone;
the second partial element includes the second attachment zone;
the third partial element is arranged between the first partial element and the second partial element; and
the first fluid channel is formed predominantly in the third partial element.

13. The electrochemical device according to claim 8, wherein:
the first fluid channel includes a throttle element; and
the throttle element is integrated, formed, and/or arranged inside of the attachment device.

14. The electrochemical device according to claim 1, wherein:
the first attachment member, the second attachment member, the third attachment member, and the fourth attachment members are configured as a plurality of elongate boreholes; and
the plurality of elongate boreholes are each configured as a circular segment-shaped elongate hole along a circular diameter about the normal axis associated with the respective attachment zone.

15. The electrochemical device according to claim 1, wherein:
the first cell stack is mounted between a first end plate and the attachment device;
the second cell stack is mounted between a second end plate and the attachment device;
the first end plate is coupled to the attachment device via a first connection element respectively; and
the second end plate is coupled to the attachment device via a second connection element respectively.

16. The electrochemical device according to claim 1, wherein:
the attachment device includes a fastening element on a mounting surface; and
the attachment device is receivable and/or holdable on a frame and/or in a housing via the fastening element.

17. The electrochemical device according to claim 1, wherein the plurality of electrochemical cells includes an anion-exchange membrane.

18. The electrochemical device according to claim 1, wherein:
the first cell stack includes a first connection member;
the second cell stack includes a second connection member; and
the first connection member and the second connection member are usable to position the plurality of electrochemical cells arranged in a stack in a fixed position relative to one another.

19. The electrochemical device according to claim 1, wherein the plurality of electrochemical cells are a plurality of electrolysis cells and/or a plurality of fuel cells.

20. The electrochemical device according to claim 8, wherein:
the first attachment member, the second attachment member, the third attachment member, and the fourth attachment member are configured as a plurality of elongate boreholes; and
the plurality of elongate boreholes are each configured as a circular segment-shaped elongate hole along a circular diameter about the normal axis associated with the respective attachment zone.

21. The electrochemical device according to claim 8, wherein:
the first cell stack is mounted between a first end plate and the attachment device;
the second cell stack is mounted between a second end plate and the attachment device;
the first end plate is coupled to the attachment device via a first connection element; and
the second end plate is coupled to the attachment device via a second connection element.

22. The electrochemical device according to claim 8, wherein:
the attachment device includes a fastening element on a mounting surface; and
the attachment device is receivable and/or holdable on a frame and/or in a housing via the fastening element.
